(19) United States
(12) Patent Application Publication
(10) Pub. No.: US 2026/0039410 A1
(43) Pub. Date: Feb. 5, 2026

(54) COVERT COMMUNICATION TECHNIQUE FOR INTELLIGENT REFLECTING SURFACE-ASSISTED WIRELESS NETWORKS WITH A FRIENDLY JAMMER

(71) Applicant: U.S. Army DEVCOM, Army Research Laboratory, Adelphi, MD (US)

(72) Inventors: Justin S. Kong, Annandale, VA (US); Fikadu T. Dagefu, Fulton, MD (US)

(73) Assignee: U.S. Government, as Represented by the Secretary of the Army, Adelphi, MD (US)

(21) Appl. No.: 18/794,370

(22) Filed: Aug. 5, 2024

(51) Int. Cl. H04K 1/10; H04B 7/04; H04K 3/00

(52) U.S. Cl. CPC H04K 1/10; H04B 7/04013; H04K 3/43

(57) ABSTRACT

We disclose a novel methodology and wireless network for covert wireless RF communications between an agent device and a client device in the presence of an adversary device which attempts to detect the existence of the transmission of the RF communication between the agent and client. The methodology comprises: providing an intelligent reflecting surface (IRS) to reflect wireless radio frequency (RF) communication signals transmitted from the agent device to the client device, the IRS comprising a two-dimensional array of individually controllable RF reflecting elements; providing a jamming device which radiates jamming signals with random power to confuse the adversary device in detecting the existence of the communication between the agent device and the client device; and establishing a covert RF communication link between the agent device and the client device using the IRS that optimizes the transmission probability, transmit power at an agent, and the reflection matrix of an IRS for covert RF communications.

### GOVERNMENT INTEREST

The invention described herein may be manufactured, used and licensed by or for the U.S. Government without the payment of royalties thereon.

### RELATED PUBLICATION

Some aspects relating to this invention have been previously disclosed by the inventors in the following paper: J. Kong, F. T. Dagefu, J. Choi, R. Aggarwal and P. Spasojevic, “Covert Communication in Intelligent Reflecting Surface Assisted Networks With a Friendly Jammer,” in IEEE Transactions on Vehicular Technology, vol. 73, no. 1, pp. 1467-1472 January 2024 (published online 31 August 2023), herein incorporated by reference in its entirety for all purposes.

### BACKGROUND OF THE INVENTION

### Field

Embodiments of the present invention are directed to a covert communication technique for intelligent reflecting surface-assisted wireless networks with a friendly jammer.

### Description of Related Art

Due to the increasing presence of adversaries and the threat they pose to both civilian and military networks, it is important to develop sophisticated secure wireless communication techniques. For many wireless communications applications, it is important to establish a covert communication system that hides the existence of the communication between a transmitter (agent) and a receiver (receiver). Some conventional methods for covert communications considered optimizing the achievable rate at a client by adjusting the transmission probability at an agent. This type of optimization has shown limited success.

Intelligent reflecting surface (IRS)-based transmission, which adaptively reconfigures wireless environments via software-controlled reflections, has gained a lot of attention as a promising technology to significantly improve the performance of wireless communication networks in an energy-efficient way as well as enhance covert communications.

In U.S. Pat. No. 11,750,319 B1, titled “Covert communication technique for intelligent reflecting surface assisted wireless networks, which issued on Sep. 5, 2023, and is herein incorporated by reference in its entirety, we disclosed a communication system that maximizes the achievable rate at a client while ensuring the covertness requirement of the transmission for IRS-assisted networks when there is noise uncertainty at an adversary. In doing so, we assumed that there is uncertainty of noise variance at an adversary. Even though covert performance can be improved in this manner, the noise uncertainty cannot be controlled thus posing challenges to implementation and control. Furthermore, it may not be possible to obtain information about the noise uncertainty at the adversary in practical scenarios.

In light of the foregoing, improvements in covert communications for intelligent reflecting surface-assisted wireless networks are desired.

### BRIEF SUMMARY OF THE INVENTION

We disclose a novel covert wireless communication network and methodology which incorporate a friendly jammer for covert communications in intelligent reflecting surface (IRS)-assisted wireless networks. It optimizes the transmission probability and transmit power at an agent, the reflection matrix of an IRS, and random jamming power with the goal of optimizing the expected rate at a client while ensuring the covertness requirement of the transmission. The methodology achieves near optimal performance and has low computational complexity since it uses only one-dimensional line search methods. It satisfies a constraint on the covertness of the transmission while maximizing the achievable communication rate to the client.

Also, the instantaneous information about both the channels to an adversary and the channel from the jammer to the client may not be available. Therefore, the agent, IRS and jammer should find their transmission strategy by using the statistic of the channels to the adversary and the channel from the jammer to the client. Lastly, to reduce the computational overhead, it is desirable to reduce the computational complexity of identifying the transmission strategy with only negligible performance loss.

This novel strategy enables one to send a confidential message to the client with the aid of an IRS in the presence of a friendly jammer. In order to mitigate the probability that the friendly communication signal is detected by an adversary, the transmission probability, the agent transmit power, the reflection matrix of the IRS in addition to the random jamming power at the jammer are jointly adjusted. This strategy can provide near-optimal performance and has low computational complexity since it uses only one-dimensional line search methods.

Our methodology can be applied to wireless RF networks communications which incorporate an IRS that reflects signals from an agent to increase the coverage region and maximize the achievable rate at a client (e.g., command post, soldier, first responder or another agent). In addition, the transmission techniques in networks should provide security to prevent malicious eavesdroppers from detecting the existence of the communication in the battlefield. We further provide a friendly jammer-assisted communication method that establishes a covert communication link between an agent and a client for IRS-assisted networks with low computational complexity and with only the statistic of the channels to an adversary and the channel from the jammer to the client.

Thus, according to one embodiment, we provide a method for covert wireless RF communications between an agent device and a client device in the presence of an adversary device which attempts to detect the existence of the transmission of the RF communication between the agent and client. It may include providing an intelligent reflecting surface (IRS) to reflect wireless radio frequency (RF) communication signals transmitted from the agent device to the client device, the IRS comprising a two-dimensional array of individually controllable RF reflecting elements; providing a jamming device which radiates jamming signals with random power to confuse the adversary device in detecting the existence of the communication between the agent device and the client device; and establishing a covert RF communication link between the agent device and the client device using said IRS that optimizes the transmission probability, transmit power at an agent, and the reflection matrix of an IRS for covert RF communications.

Establishing a covert RF communication link between the agent device and the client device using the IRS that optimizes the transmission probability, transmit power at an agent, and the reflection matrix of an IRS for covert RF communications may include determining a transmission probability λ between the agent device and the client device, a transmit power P at an agent, random jamming power of the jamming device P_{J}[s] and an IRS reflection matrix Θ for configuration data for the IRS elements to optimize an achievable data rate at a client R̅_{C} while ensuring covertness of the transmission. More particularly, this step may include: (a) determining a transmission probability λ between the agent device and the client device that optimizes the achievable data rate at the client device taking into account an expected detection error probability (DEP) at an adversary device; (b) determining the transmit power P of the agent that satisfies covertness of the transmission for the RF communication for the determined transmission probability λ and the interval of random jamming power P_{J}[s]; and (c) determining phase calculations of the n-th IRS elements of the IRS θₙ[s]. In some embodiments and implementation, an approximation of achievable rate at the client \tilde{R}_{C} is used for the actual achievable data rate at the client R̅_{C}.

In the aforementioned method, the “determining” in step (a) may be performed using an extremum-finding algorithm. For instance, this may be a golden section search scheme as a non-limiting example. The “obtaining” in step (b) may be performed using a root-finding algorithm, such as, for instance, a bisection method. The IRS reflection matrix may be defined as Θ=diag {e^{jθ}^{₁}, e^{jθ}^{₂}, . . . , e^{jθ}^{_{N}}} and the “determining” in step (c) is computed according to the following equation: θₙ=arg(h_{C})−arg(g_{C,n})−arg(h_{I,n}), ∀n, where arg(α) is the angle of complex scalar α, and g_{C,n} and h_{I,n} indicate the n-th elements of g_{C} and h_{I} of the IRS, respectively.

Additionally, the method may include wirelessly transmitting the determined IRS reflection matrix Θ from the agent device to the IRS. Plus, it may include configuring the IRS for RF communication between the agent device and the client device based on the determined IRS reflection matrix Θ. And configuring the jamming device to operate with random jamming power.

According to another embodiment, we provide a wireless network for covert wireless RF communications between an agent device and a client device in the presence of an adversary device which attempts to detect the existence of the transmission of the RF communication between the agent and client. It includes an intelligent reflecting surface (IRS) comprising a 2D array individually-controllable RF reflecting elements to reflect a wireless radio frequency (RF) signals transmitted from an agent device to an client device as well as a jamming device which radiates jamming signals with random power to confuse the adversary device in detecting the existence of the communication between the agent device and the client device; and a controller configured to establish a covert RF communication link between the agent device and the client device using the IRS that optimizes the transmission probability, transmit power at an agent, and the reflection matrix of an IRS for covert RF communications.

The controller be configured to establish said covert RF communication link by the aforementioned methodology. The IRS may be comprised at least 20 RF reflecting elements in some implementations. Each of the individually controllable RF reflecting elements is configured to provide a phase shift to the reflected signal. More, in some embodiments, the wireless network may include at least one agent device and at least of client device.

These and other embodiments of the invention are described in more detail, below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments, including less effective but also less expensive embodiments which for some applications may be preferred when funds are limited. These embodiments are intended to be included within the following description and protected by the accompanying claims.

FIG. 1 is a schematic illustration of a network scenario and depict key variables involved in the novel methodologies used in embodiments of the present invention.

FIGS. 2A and 2B show the architecture of a conventional intelligent reflecting surface.

FIG. 3 and FIG. 3A are flow charts depicting the novel methodology according to one embodiment of the invention.

FIG. 4 depicts a simplified high-level block diagram of an exemplary transceiver for an agent device in accordance with an embodiment.

FIG. 5 is a schematic illustration of an exemplary network scenario in accordance with an embodiment. FIGS. 5A-5C are plots showing some numerical simulation results for said exemplary network scenario.

FIGS. 6-8 are additional plots of the covert data rate based on the exemplary network scenario in FIG. 5.

### DETAILED DESCRIPTION

Our novel networks and methodologies disclosed herein utilize an intelligent reflecting surface (IRS) and a “friendly” jamming (transmission/broadcast) device.

We believe there are three key challenges in designing friendly jammer-assisted covert communication techniques for wireless networks with an IRS and a jamming device which are as follows: (1) computing the IRS reflection matrix, transmit power at an agent, jamming power at the friendly jamming device which ensure covertness of the communication, (2) identifying an approximation of the analytical expression of the achievable rate at a client as a function the transmission probability at the agent when the transmit power at the agent, IRS matrix at the IRS and jamming power are adjusted to ensure covertness of the communication, (3) obtaining the transmission probability that maximizes the approximated achievable rate at the client. Moreover, in order to mitigate the computational overhead, it is desirable to reduce the computational complexity of identifying the transmission strategy with only negligible performance loss.

Considering these challenges, our novel methodology enables sending confidential messages to the client with the aid of an IRS in the presence of a jamming (transmission/broadcast) device.

In order to reduce the probability that the friendly communication signal is detected by an adversary, we design a system that enhances the expected achievable rate at a client while ensuring the covertness of the communication (the expected detection error probability (DEP) at an adversary should be higher than a target DEP). To this end, we seek to determine an optimization of transmission probability at an agent, transmit power at the agent, reflection matrix, and random jamming power. In this way, we hope to enhance the achievable rate at a client, ensure the covertness of the transmission, require only one-dimensional line search methods (low computational complexity), require the statistic information about the channels to the adversary and the channel from the jammer, and do not require any instantaneous information about the channels to the adversary and the channel from the jammer.

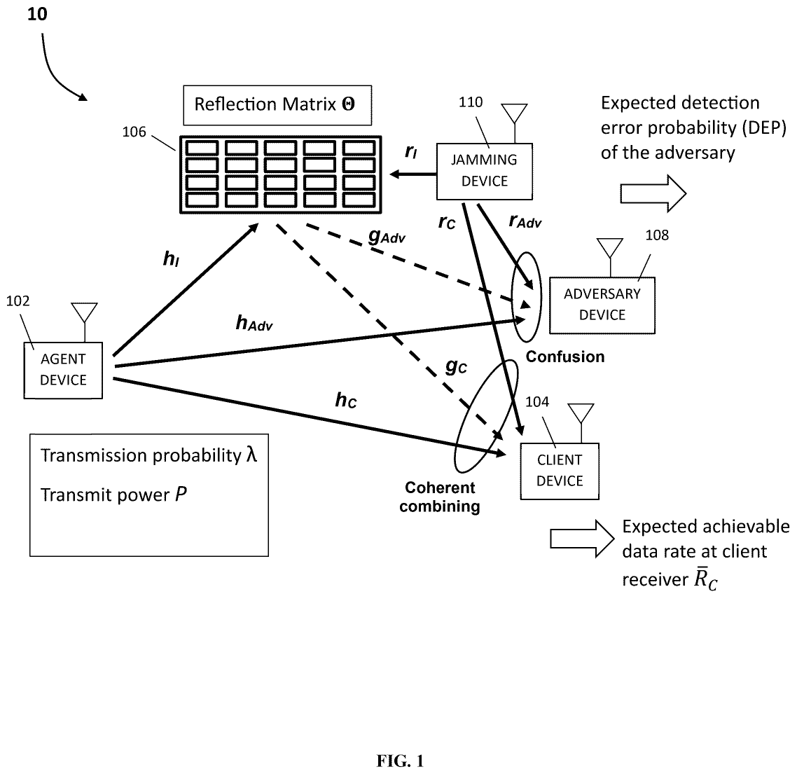

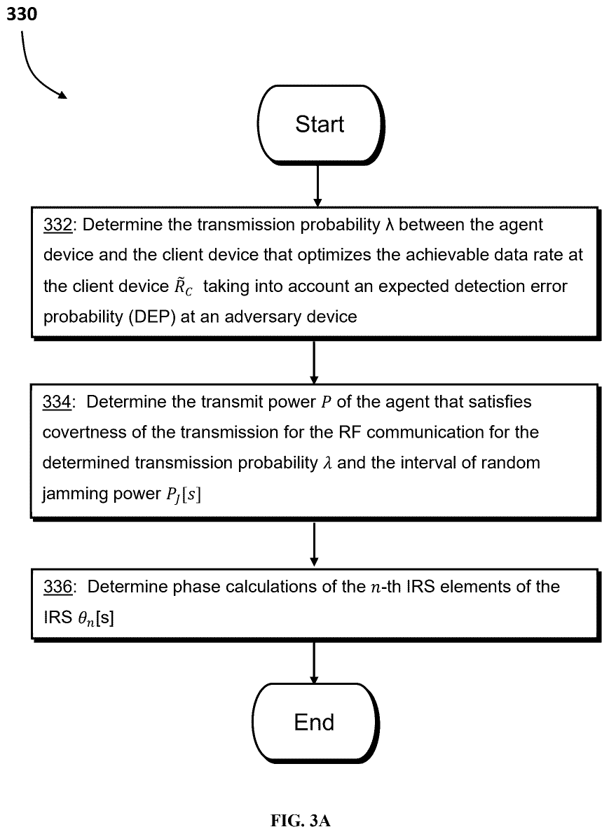

FIG. 1 is a schematic illustration depicting an exemplary wireless communications network 10 in accordance with embodiments of the present invention. The wireless network 10 is formed of an agent device 102, a client device 104, and an intelligent reflecting surface (IRS) 106. The client may be an individual (e.g., a soldier, warfighter, commercial user) equipped with or otherwise using a radio. While one client device is depicted in the figure, there could be others. Although, our methodology 300 (FIGS. 3 and 3A) is specifically designed to RF transmission from one agent to one client.

In accordance with embodiments, we further provide the network 10 with a jamming device (also referred to as a “jammer” or “jamming agent”) 110 that radiates jamming signals with random power to produce uncertainty about the received signal strength at the adversary that can confuse the adversary in detecting the existence of the communication between an agent and a client. We refer to the jamming device 110 as “friendly” because it is under control/operated by same party (entity) who controls and operates the agent devices 102, client devices 104 and IRS 106.

The friendly jamming device 110 can be any broadcast transmitter. For instance, at least one of agent devices 102, client devices 104 or auxiliary nodes can be the friendly jamming device 110. The jamming device's 110 role is to broadcast artificial random jamming signals (not data) with the aim of confusing the adversary. The jamming device randomly chooses its jamming power from a uniform distribution in [P_{lb}, P_{ub}]. So, there are two optimization variables for the jamming power (P_{lb} and P_{ub}). We assume that all transmissions (including jamming) use the same frequency. For instance, the jamming device 110 transmits “dummy” data so it can be any determined complex value for randomly generated complex value, like white noise. The jamming signals become interference at the legitimate receiver, i.e. the client 104. Therefore, those are optimized with the goal of maximizing the expected achievable rate at the legitimate receiver while ensuring a requirement on the covertness.

A potential adversary 108 may be located in a position to intercept or eavesdrop on RF communications between an agent 102 and the client 104. Potential adversaries 108 often utilize passive receiving devices and conceal their presence. They could be individuals with suitable RF devices or passive RF detectors sensors (also known as RF “sniffers” or “bugs”). Thus, their presence may not be known or otherwise detected by the agent 102 or client 104.

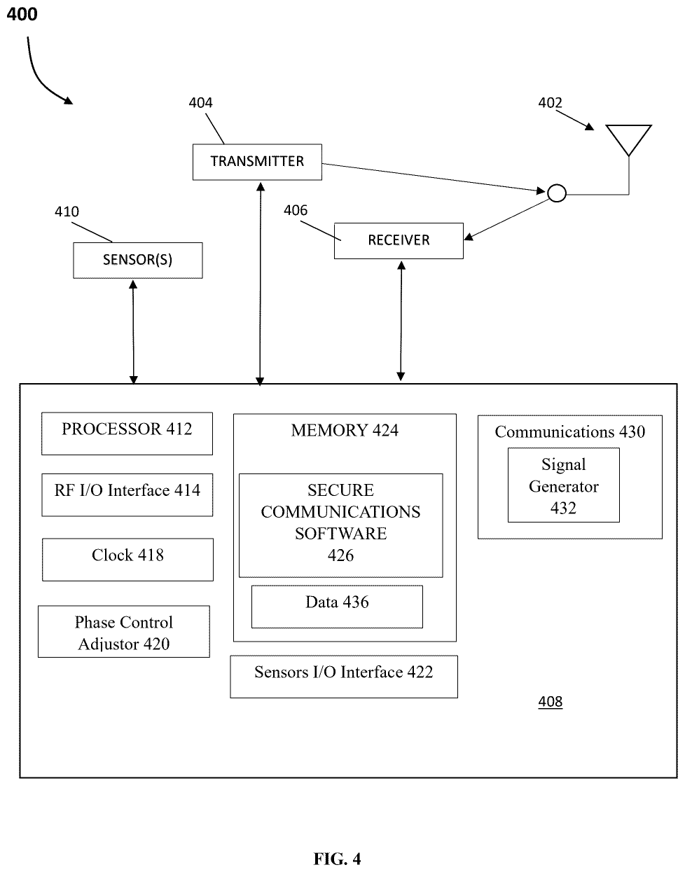

The agent device 102, client device 104 and jamming device 110 are equipped with at least one antenna and other hardware for receiving/transmitting RF communications. FIG. 4 shows further details of the agent device 102 (and which can also be used for the client device 104 and the jamming device 110). The adversary device 108 is assumed to have an antenna and processing means for RF communications, but the particulars are generally unknown to those in the network 10.

The agent device 102 and the client device 104 are geometrically separated from one another in two-dimensional (2D) space, as shown, or it could be three-dimensional (3D) space. The agent communicates with the client. Our methodology presumes that the agent device 102 transmits a RF communication which the client device 104 receives. We call this an uncontrolled signal. In addition, the agent device 102 transmits a RF communication to the IRS 106 reflects and augments that RF communication which the client device 104 also receives. The former is uncontrolled while the latter is controlled by the IRS 106. We control the friendly jamming device 110 too.

The role of the agent and client devices may continually reverse, in that, the client becomes an agent and transmits communications, and the agent becomes a client and receives the communication. The methodology described herein may repeat for the new agent and new client again and again as needed. This allows for truly two-wave and/or duplex communications among the devices.

In embodiments, the agent device 102, client device 104 and jamming device 110 may be an autonomous vehicle, a mobile command station or an individual carrying a transceiver. The agent device 102 and client device 104 may be fixed or mounted on a ground-based, air-borne sea-borne, or space-based platform. So may be the jamming device 110. The agent device 102 and client device 104 (and optionally the jamming device 110) may be equipped with cameras and microphones for providing image/video data and sound/voice data. Additionally, they may be equipped with various sensor(s) for providing other information. Some non-limiting examples of sensors may include: additional or multispectral imaging (UV/visible/IR); antennas (RF; radio); ranging (radar; LIDAR); location/position sensors (GPS, altitude/depth, etc.), motion sensors (speed/velocity, bearing/trajectory, acceleration, etc.); weather sensors (temperature, pressure, wind speed, ambient lighting, etc.); and field sensors (electric, magnetic, vibrations, radiation, biological, etc.). Of course, other sensors and sensor information may also be provided for as may be desirable.

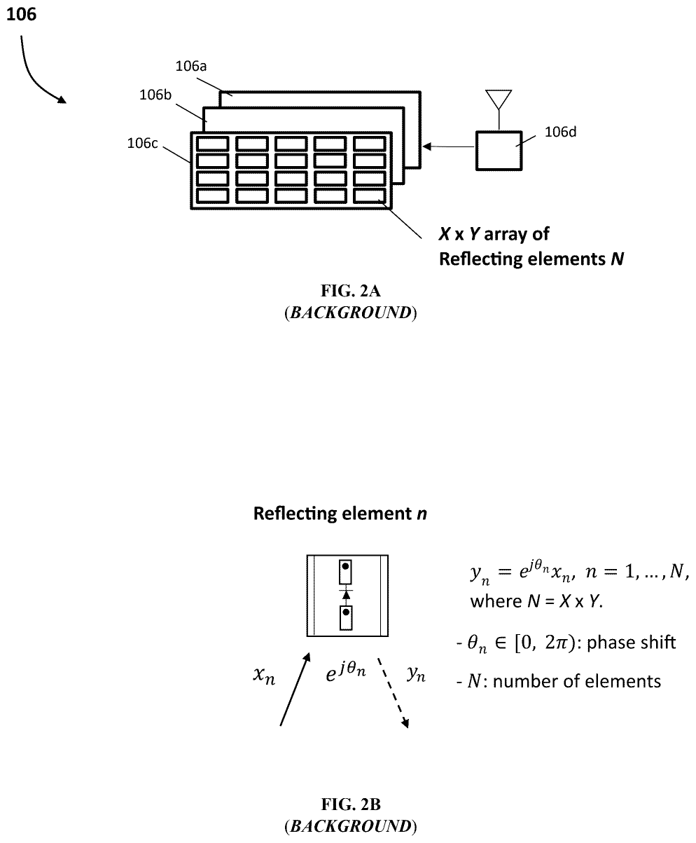

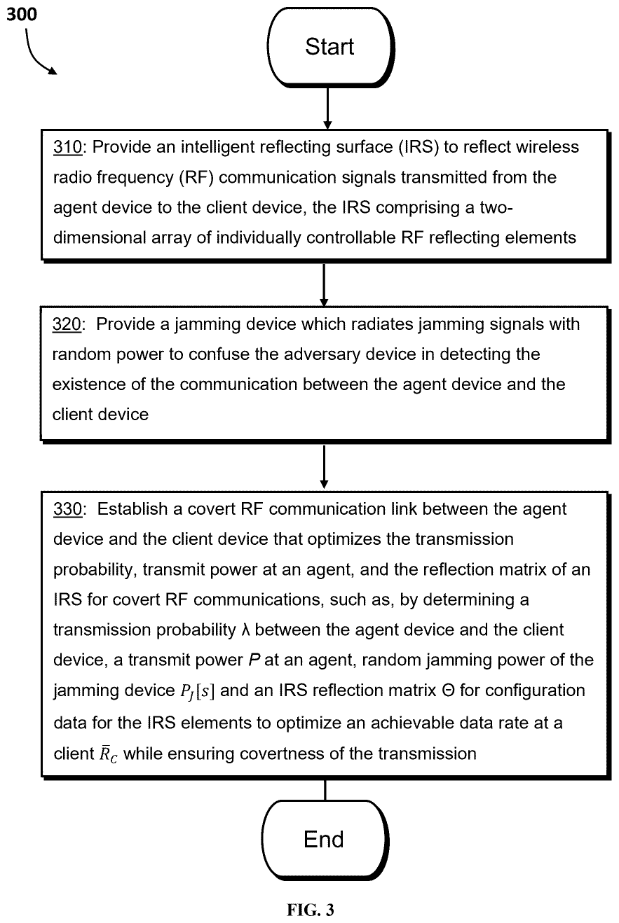

We illustrate the various RF signal channels involved: h_{I}, h_{Adv}, h_{C}, g_{C}, g_{Adv}, r_{C} r_{I} and r_{Adv}. They include direct and reflected transmissions channels. More particularly, the direct ones include: (i) the transmission channel from the agent device 102 to the client device 104, h_{c}; (ii) the transmission channel from the agent device 102 to the adversary device 108, h_{Adv}; and (iii) the transmission channel from the agent device 102 to the IRS 106, h_{I}. And the reflected ones include: (iv) the transmission channel from IRS 106 to the client device 104, g_{C}; and (v) the transmission channel from the IRS 106 to the adversary device 108, g_{Adv}. From the jamming device 110, the pertinent channels of interest include: i) the channel to the client device 102, r_{C}; (ii) the channel to the adversary device 108, r_{Adv}; and (iii) the channel to the IRS 106, r_{I}. Note: we use solid lines to represent direct transmission and dotted lines to represent reflections from the IRS. The reflected signals (g_{C} and g_{Adv}) are augmented by the IRS 106 as later explained with respect to FIGS. 2A and 2B.

In actuality, the agent device 102 and the jamming device 110 each transmit one RF signal which radiates in multiple directions. Of particular interest, from the agent device 102, are signal in the directions to the client device 104, the IRS 106, and the adversary device 108. We refer to them as channels: h_{C}, h_{I}, and h_{Adv}, respectively. There is one channel impinging on the IRS 106, h_{I}.

The IRS 106 reflects and augments the signal from the agent device 102 and the signal from the jamming device 110, as discussed herein. It too radiates in multiple directions. Of particular interest are the augmented reflected signal in the directions to the client device 104 and the adversary device 108. We refer to them as channels: g_{C} and g_{Adv}, respectively.

In keeping with the goals of our novel methodology, we seek coherent combining of channels h_{C}, g_{C} and r_{C} at the client device 104. And we seek to ensure confusion with channels h_{Adv}, g_{Adv} and r_{Adv} at the adversary device 108.

Intelligent reflecting surfaces (IRS) for wireless RF communications are generally known and discussed in the open literature. See, for example, Wankai Tang et al., “Wireless Communications With Reconfigurable Intelligent Surface: Path Loss Modeling and Experimental Measurement,” IEEE Transactions on Wireless communications, 20(1), January 2021, pp. 421-439; and Qingqing Wu and Rui Zhang “Towards Smart and Reconfigurable Environment: Intelligent Reflecting Surface Aided Wireless Network,” IEEE Communications Magazine, 58(1), January 2020, pp. 106-112, herein incorporated by reference in their entirety.

FIGS. 2A and 2B show the architecture of a conventional IRS adapted from the Wu et al. (2021) paper. We can use the same IRS components for the IRS 106 in various embodiments of the present invention. Thus, we will only briefly describe here as one can turn to the aforementioned references for further details. As shown in FIG. 2A, the IRS 106 is generally composed of a printed circuit board 106a, conductive metal backplane 106b, and an outer reflecting surface 106c having plurality of reflecting elements which are controlled by an IRS controller 106d. The reflecting elements of the surface 106c are arranged in a 2D array represented by the number of rows and columns of elements, X and Y, respectively. Thus, the number of reflecting elements N of IRS 106 is simply equal to X×Y. In Table II of the Tang paper, they considered different number of rows and columns of elements for their IRS. For adequate control of the communications using the IRS, we believe there should be at least 20 RF reflecting elements. We considered our numerical simulations for an IRS with 50 RF reflecting elements. The number of reflecting elements may be 100 or more in other embodiments. Even larger numbers of reflecting elements, for instance, up to and exceeding 1000, may be used in still further embodiments.

According to our embodiment, the IRS 106 may be fixed (static) or could be movable. The novel methodology assumes that channels are known; so, when the channels vary, we have to update solutions using the changed channels either way. For static IRSs, they may be mounted on a building, cell phone tower or other tall structure. And, for moving IRSs, they may be mounted on various platforms, including, for instance, space-based (e.g., satellites, rocket ships, space stations, etc.), air-based vehicles (e.g., aircraft, helicopter, blimp, UAV, etc.), ground-based (e.g., cars, trucks, military vehicles, and mobile command center, etc.), and sea-based (ships, submarines, etc.) as some non-limiting examples.

FIG. 2B illustrates an example of an individual reflecting element's structure for the IRS 106. It is composed of a PIN diode is embedded in each reflecting element n. By judiciously controlling the biasing DC voltage, the PIN diode can be switched “On” and “Off” thereby generating a phase-shift difference. Although, we note other types and designs of IRS may certainly be used.

Each reflecting element can be individually controlled with its own biasing voltage signal from the IRS controller. The reflecting element receives an incoming RF signal xₙ and outputs a reflected augments signal yₙ=e^{jθ}^{ₙ}xₙ, n=1, . . . , N, where N=X×Y, and θₙ is the phase shift. The phase shift may range from 0 to ±2π radians.

To control the reflection amplitude, a variable resistor load can be applied in the element design. By changing the values of resistors in each of the reelecting elements, different portions of the incident signal's energy are dissipated, thus achieving controllable reflection amplitude between 0 and 1 (0 to 100%). The amplitude and phase shift at each element of the IRS may be independently controllable. In our methodology, we only focus on phase shift though.

We further illustrate in FIG. 1 the key variables involved in the novel methodologies used in embodiments of the present invention. They include: (a) a transmission probability λ between the agent device and the client device; (b) a transmit power P at an agent; (c) an expected achievable data rate at client receiver R̅_{C}; (d) an expected detection error probability (DEP) of the adversary device, and (e) an IRS reflection matrix Θ. We will briefly discuss each of these variables.

The transmission probability λ between the agent device and the client device represents the statistical likelihood, under the circumstances, that a RF transmission sent from the agent device is received by the client device. The value is unitless and varies from 0 to 1 (0 to 100%). We intentionally vary λ to achieve the aforementioned goals.

The transmit power P at the agent device is the transmission power of the agent device. It is controlled by the trans-receiver of the agent device. It may be given in terms of power, such as in units of Watt(s) or decibels per milliwatt (dBm). We optimize P to achieve the aforementioned goals. The maximum transmission power Pₘₐₓ is an inherent property of the transmitted of the agent and is an upper bound of the optimized transmit power.

The expected achievable data rate at client device R̅_{C} represents the statistical data rate which under the circumstances would be expected at the client device receiver. We also refer to it herein as the covert data rate. It is a function of the transmission probability λ between the agent device and the client device, and the powers of the both the signal directly transmitted by the agent device to the client and the signal from the client that is reflected and augmented by the IRS. This value may be given as a bandwidth, such as in units of bits-per-second (bps) per Hz or bps/Hz. We seek to optimize R̅_{C}. However, because we are unable to derive an exact expression of the expected rate at the client R̅_{C}, we use an approximation thereof, \tilde{R}_{C}.

The reflection matrix Θ represents configuration information for the intelligent reflecting surface's elements. It may be a 2-D array of data that includes the phase augmentation information for the RF reflecting elements of the IRS. The IRS reflects N incoming signals. The received signal via IRS at the client is defined as

$${\sum }_{n = 1}^{N} {g}_{C , n} {e}^{j {θ}_{n}} {h}_{I , n} .$$

We used matrix Θ just to simply express

$${\sum }_{n = 1}^{N} {g}_{C , n} {e}^{j {θ}_{n}} {h}_{I , n} as {g}_{c}^{T} {Θ h}_{I} .$$

The IRS's controller adjust the N elements based on the matrix data Θ. These values may be reported as θₙ, for instance, as phase shifts for the n-th incoming signal; the values will range from 0 to 2π radians (0 to 360°).

The following detailed description of the invention uses various notations and equations to describe the operation of the invention. Table 1 below lists a definition for each of the notations used below. The latter portion of parameters are tunable parameters.

TABLE 1
LIST OF NOTATIONS

| Notation | Definition |
|---|---|
| L | number of channels uses in a communication slot |
| I | channel index in a slot |
| S | slot index |
| N | the number of elements at IRS |
| a~CN(0, χI_{N}) | means a (N by 1 vector) is a complex gaussian random |
| | variable with variance χ where I_{N} is the identical matrix with |
| | size N by N |
| x_{A}[s, l] | the transmit data at the agent in the l-th channel use in slot s |
| x_{J}[s, l] | the transmit data at the friendly jammer in the l-th channel use |
| | in slot s |
| ${h}_{C} [ s ] \sim CN ( 0 , {σ}_{{h}_{C}}^{2} )$ | channel between the agent and client in slot s |
| ${h}_{Adv} [ s ] \sim CN ( 0 , {σ}_{{h}_{Adv}}^{2} )$ | channel between the agent and adversary in slot s |
| ${h}_{I} [ s ] \sim {ℂ}^{N \times 1} \sim CN ( 0 , {σ}_{{h}_{I}}^{2} {I}_{N} )$ | channel between the agent and IRS in slot s |
| ${g}_{C} [ s ] \sim {ℂ}^{N \times 1} \sim CN ( 0 , {σ}_{{g}_{C}}^{2} {I}_{N} )$ | channel between the IRS and client in slot s |
| ${g}_{Adv} [ s ] {ℂ}^{N \times 1} \sim CN ( 0 , {σ}_{{g}_{Adv}}^{2} {I}_{N} )$ | channel between the IRS and adversary in slot s |
| ${r}_{C} [ s ] \sim CN ( 0 , {σ}_{{r}_{C}}^{2} )$ | channel between the jammer and client in slot s |
| ${r}_{Adv} [ s ] \sim CN ( 0 , {σ}_{{r}_{Adv}}^{2} )$ | channel between the jammer and adversary in slot s |
| ${r}_{I} [ s ] ∈ {ℂ}^{N \times 1} \sim CN ( 0 , {σ}_{{r}_{I}}^{2} {I}_{N} )$ | channel between the jammer and IRS in slot s |
| ${n}_{C} [ s , l ] \sim CN ( 0 , {σ}_{C}^{2} )$ | noise at the client |
| ${n}_{Adv} [ s , l ] \sim CN ( 0 , {σ}_{Adv}^{2} )$ | noise at the adversary |
| y_{C}[s, l] | the received signal at the client in the l-th channel use in slot s |
| y_{Adv}[s, l] | the received signal at the adversary in the l-th channel use in |
| | slot s |
| ${σ}_{C}^{2}$ | variance of the noise at the client |
| ${σ}_{Adv}^{2}$ | variance of the noise at the adversary |
| ${σ}_{{h}_{C}}^{2} , {σ}_{{h}_{Adv}}^{2} , {σ}_{{h}_{I}}^{2} , {σ}_{{g}_{C}}^{2} , {σ}_{{g}_{Adv}}^{2} , {σ}_{{r}_{C}}^{2} , {σ}_{{r}_{Adv}}^{2} , and {σ}_{{r}_{I}}^{2}$ | large scale path loss of the corresponding channels |
| P_{E}[s] | DEP in slot s |
| P̅_{E} | expected DEP where the expectation is over slots. |
| R̅_{C} | expected achievable rate at the client where the expectation is |
| | over slots |
| \tilde{R}_{C} | approximation of achievable rate at the client where the |
| | expectation is over slots |
| ϵ | target DEP |
| P_{A,max} | maximum available transmit power at the agent |
| P_{J,max} | maximum available transmit power at the jammer |
| G | Gain |
| Tunable parameters | |
| P_{A} | transmit power at agent (optimization variable) |
| λ | transmission probability at agent (optimization variable) |
| P_{J}[s] | random power of a jamming signal in slot s |
| P_{lb} | lower bound of the random jamming power (optimization |
| | variable) |
| P_{ub} | upper bound of the random jamming power (optimization |
| | variable) |
| Θ | IRS matrix which is computed every slot (optimization |
| | variable) |
| θₙ | the phase shift of the n-th IRS element |
| γ[s] | detection threshold at the adversary in slot s (optimized at the |
| | adversary) |

The quasi-static Rayleigh fading channels are considered. A communication slot consists of a block of L channel uses, and all channels remain constant in a slot and change to independent channels for the next slot. In order to confuse the adversary, the agent decides whether to transmit a signal with power P_{A} or not in every slot. More specifically, for a given slot, the agent transmits a signal with transmission probability λ. In slot s, the IRS identifies its reflection coefficient matrix Θ[s] based on the channels in slot s where Θ[s]=diag{e^{jθ}^{₁}^{[s]}, e^{jθ}^{₂}^{[s]}, . . . , e^{jθ}^{_{N}}^{[s]}}∈ [symbol] and θₙ[s]∈[0,2π) is the phase shift of the n-th IRS element.

In addition, with the goal of obfuscating the adversary in detecting the communication, in slot s, the jammer broadcasts a jamming signal with random power P_{J}[s] where the jamming power follows a uniform distribution in [P_{lb}, P_{ub}].

Here, the transmission probability at the agent A, transmit power at the agent P_{A}, and the jamming power P_{J} [s], between Pub and Pub, do not change from one slot to another, but the IRS reflection matrix [s] and jamming power P_{J}[s] may and thus can be different for different slots.

We define x_{A}[s,l]˜CN(0,1) and x_{J}[s,l]˜CN(0,1) as the transmit signals from the agent and jammer in the l-th channel use in slot s where CN(a, b) means the complex Gaussian random variable with mean a and variance b. Then, the received signals at the client and adversary are respectively expressed as:

$${y}_{c} [ s , l ] = \sqrt{{P}_{A}} ( {h}_{c} [ s ] + {g}_{c}^{T} [ s ] Θ [ s ] {h}_{I} [ s ] ) {x}_{A} [ s , l ] + \sqrt{{P}_{J} [ s ]} ( {r}_{c} [ s ] + {g}_{c}^{T} [ s ] Θ [ s ] {r}_{I} [ s ] ) {x}_{J} [ s , l ] + {n}_{c} [ s , l ] , \qquad ( 1 )$$

$${y}_{Adv} [ s , l ] = \sqrt{{P}_{A}} ( {h}_{Adv} [ s ] + {g}_{Adv}^{T} [ s ] Θ [ s ] {h}_{I} [ s ] ) {x}_{A} [ s , l ] + \sqrt{{P}_{J} [ s ]} ( {r}_{Adv} [ s ] + {g}_{c}^{T} [ s ] Θ [ s ] {r}_{I} [ s ] ) {x}_{J} [ s , l ] + {n}_{Adv} [ s , l ] , \qquad ( 2 )$$

$$where$$

$${h}_{c} [ s ] ∼ CN ( 0 , {σ}_{{}^{h} C}^{2} ) and {h}_{Adv} [ s ] ∼ CN ( 0 , {σ}_{{}^{h} Adv}^{2} )$$

represent the channels from the agent to client and the agent to adversary, respectively. Also,

$${h}_{I} [ s ] ∈ {ℂ}^{N \times 1} ∼ C N ( 0 , {σ}_{{h}_{I}}^{2} {I}_{N} ) , {g}_{C} [ s ] ∈ {ℂ}^{N \times 1} ∼ C N ( 0 , {σ}_{{g}_{C}}^{2} {I}_{N} ) and {g}_{Adv} [ s ] ∈ {ℂ}^{N \times 1} ∼ C N ( 0 , {σ}_{{g}_{Adv}}^{2} {I}_{N} )$$

stand for the channels from the agent to the IRS, from the IRS to client, and from the IRS to adversary, respectively, where I_{N} denotes N×N identity matrix. Here,

$${r}_{C} [ s ] ∼ C N ( 0 , {σ}_{{r}_{C}}^{2} ) , {r}_{Adv} [ s ] ∼ C N ( 0 , {σ}_{{r}_{Adv}}^{2} ) and {r}_{I} [ s ] ∈ {ℂ}^{N \times 1} ∼ C N ( 0 , {σ}_{{r}_{I}}^{2} {I}_{N} )$$

are the channels from the jammer to the agent, adversary and IRS, respectively. Here

$${σ}_{{h}_{C}}^{2} , {σ}_{{h}_{Adv}}^{2} , {σ}_{{h}_{I}}^{2} , {σ}_{{g}_{C}}^{2} , {σ}_{{g}_{Adv}}^{2} , {σ}_{{r}_{C}}^{2} , {σ}_{{r}_{Adv}}^{2} and {σ}_{{r}_{I}}^{2}$$

mean the large-scale path losses of the corresponding channels. In addition,

$${n}_{C} [ s , l ] ∼ C N ( 0 , {σ}_{C}^{2} ) and {n}_{Adv} [ s , l ] ∼ C N ( 0 , {σ}_{Adv}^{2} )$$

are the complex additive Gaussian noise at the client and adversary, respectively.

The adversary has knowledge of the transmit power at the agent P_{A}, transmission probability at the agent λ, the jamming power P_{J}[s] between P_{lb} and P_{ub}, the effective channel gains to the adversary

$${{η}_{A} [ s ] {=}^{Δ} {\vert {h}_{A d v} [ s ] + {g}_{Adv}^{T} [ s ] Θ [ s ] {h}_{I} [ s ] \vert}^{2} and {η}_{J} [ s ] {=}^{Δ} \vert {r}_{Adv} [ s ] + {g}_{Adv}^{T} [ s ] Θ [ s ] {r}_{I} [ s ] ] \vert}^{2} .$$

This case presents the worst-case scenario from covertness perspective.

The agent and IRS have knowledge of their channels to the client (h_{C}[s], g_{C}[s] and h_{I}[s]) and the statistics of the channels

$$( {σ}_{{h}_{C}}^{2} , {σ}_{{g}_{C}}^{2} , and {σ}_{{h}_{I}}^{2} ) .$$

However, the agent and IRS only know the statistics of the effective channels to the adversary and do not have information about the instantaneous channels to the adversary (h_{Adv}[s], g_{Adv}[s], and r_{Adv}[s]) in every slot. Furthermore, the agent and IRS only have knowledge of the statistics of the channels from the jammer to the client

$$( {σ}_{{r}_{C}}^{2} and {σ}_{{r}_{I}}^{2} )$$

and do not know the instantaneous channels from the jammer to the client (r_{C}[s] and r_{I}[s]) in every slot.

In order to detect the existence of the transmission, the adversary attempts to distinguish the following two hypotheses:

$${ℋ}_{0} [ s ] : {y}_{Adv} [ s , l ] = \sqrt{{P}_{J} [ s ]} ( {r}_{Adv} [ s ] + {g}_{Adv}^{T} [ s ] Θ [ s ] {r}_{I} [ s ] ) {x}_{J} [ s , l ] + {n}_{Adv} [ s , l ] , \qquad ( 3 a )$$

$${ℋ}_{1} [ s ] : {y}_{Adv} [ s , l ] = \sqrt{{P}_{A}} ( {h}_{Adv} [ s ] + {g}_{Adv}^{T} [ s ] Θ [ s ] {h}_{I} [ s ] ) {x}_{A} [ s , l ] + \sqrt{{P}_{J} [ s ]} ( {r}_{Adv} [ s ] + {g}_{Adv}^{T} [ s ] Θ [ s ] {r}_{I} [ s ] ) {x}_{J} [ s , l ] + {n}_{Adv} [ s , l ] , \qquad ( 3 b )$$

where [symbol] [s] designates the null hypothesis in which there is no transmission and [symbol] [s] signifies the alternative hypothesis in which there is a transmission in slot s.

In slot s, based on the observations y_{Adv}[s, 1], . . . , y_{Adv}[s, L], the adversary makes a binary decision whether the agent's transmission happened or not. The adversary employs a radiometer for the binary decision and conducts a threshold test as follows:

$${y}_{Adv} [ s ] {=}^{Δ} \frac{1}{L} {\sum }_{l = 1}^{L} {\vert {y}_{A d v} [ s , l ] \vert}^{2} {≷}_{{𝒟}_{0} [ s ]}^{{𝒟}_{1} [ s ]} γ [ s ] , \qquad ( 4 )$$

where γ[s] is the detection threshold in slot s, and [symbol] [s] and [symbol] [s] respectively denote the decisions in favor of [symbol] [s] and [symbol] [s].

Then, for slot s, the detection error probability (DEP) at the adversary P_{E}[s] is given by:

$${P}_{E} [ s ] = λ {𝒫}_{M D} [ s ] + ( 1 - λ ) {𝒫}_{F A} [ s ] , \qquad ( 5 )$$

where [symbol] [s]=Pr( [symbol] [s]| [symbol] [s]) and [symbol] [s]=Pr( [symbol] [s]| [symbol] [s]) are respectively the missed detection probability and the false alarm probability.

In every slot s, the adversary computed the optimal detection threshold γ[s] that minimizes the DEP P_{E}[s] and makes a binary decision following the threshold test. The expected DEP over slots is defined by as

$${\overline{P}}_{E} {=}^{Δ} 𝔼 [ {P}_{E} [ s ] ] .$$

Since the probability that the agent transmits data to the client is λ, the expected achievable rate at the client R̅_{C} is given by:

$${\overline{R}}_{C} = λ 𝔼 [ {log}_{2} ( 1 + \frac{{P}_{A} {\vert {h}_{C} [ s ] + {g}_{C}^{T} [ s ] Θ [ s ] {h}_{I} [ s ] \vert}^{2}}{{P}_{J} [ s ] {\vert {r}_{C} [ s ] + {g}_{C}^{T} [ s ] Θ [ s ] {r}_{I} [ s ] \vert}^{2} + {σ}_{C}^{2}} ) ] , \qquad ( 6 )$$

where the expectation is taken over slots. The goal of this invention is to maximize R̅_{C} while satisfying the covertness constraint on the expected DEP at the adversary, i.e., P̅_{E} should be larger than a target DEP ε. We term the achieved R̅_{C} with the covertness constraint as covert rate.

Here, we provide a new covert communication technique that jointly optimizes the transmit power at the agent P_{A}, the transmission probability at the agent λ, the IRS reflection matrices {Θ[s]}, the random jamming power Pⱼ[s] for the covert rate maximization problem. The covert rate maximization problem is formulated as:

$${max}_{\{ Θ [ s ] \} λ , {P}_{A} , {P}_{lb} , {P}_{ub}} \begin{matrix}{\overline{R}}_{C} & \begin{matrix}s . t . & {P}_{A} \leq {P}_{A , max} , {P}_{u b} \leq {P}_{J , max} and {\overline{P}}_{E} \geq ϵ\end{matrix}\end{matrix} , \qquad ( 7 )$$

where P_{A,max} and P_{J,max} are the maximum available transmit powers at the agent and jammer, respectively. Here, ϵ∈[0, min(λ, 1−λ)) since the maximum achievable P̅_{E} is [0, min(λ, 1−λ)) when λ is known at the adversary.

Note that the instantaneous channels to the adversary (h_{Adv}[s], g_{Adv}[s], and r_{Adv}[s]) and the instantaneous channels from the jammer (r_{C}[s] and r_{I}[s]) are not available at the agent and IRS. Hence, to enhance the achievable rate at the client based on only the available channel information, Θ[s]=diag{e^{jθ}^{₁}^{[s]}, e^{jθ}^{₂}^{[s]}, . . . , e^{jθ}^{_{N}}^{[s]}} is calculated to maximize the strength of the received signal at the client from the agent

$${P}_{A} {\vert {h}_{C} [ s ] + {g}_{C}^{T} [ s ] Θ [ s ] {h}_{I} [ s ] \vert}^{2} .$$

Then, the reflection coefficient θₙ[s] is obtained as:

$${θ}_{n} [ s ] = arg ( {h}_{C} [ s ] ) - arg ( {g}_{C , n} [ s ] ) - arg ( {h}_{I , n} [ s ] ) , ∀ n , \qquad ( 8 )$$

where arg(α) is the angle of complex scalar α, and g_{C,n}[s] and h_{I,n}[s] indicate the n-th elements of g_{C}[s] and h_{I}[s], respectively.

When the number of channel uses in a slot is large enough, by the Strong Law of Large Numbers,

$${y}_{Adv} [ s ] = {P}_{J} [ s ] {η}_{J} [ s ] + {σ}_{Adv}^{2}$$

when [symbol] and

$${y}_{Adv} [ s ] = {P}_{A} {η}_{A} [ s ] + {P}_{J} [ s ] {η}_{J} [ s ] + {σ}_{Adv}^{2}$$

when [symbol] . As the jamming power P_{J}[s] follows a uniform distribution in [P_{lb}, P_{ub}], when the adversary computes the detection threshold γ[s] that minimizes P_{E}[s], the DEP P_{E}[s] is expressed as

$${P}_{E} [ s ] = \{ \begin{matrix}min ( λ , 1 - λ ) ( 1 - \frac{{P}_{A} {η}_{A} [ s ]}{{η}_{A} [ s ] ( {P}_{ub} - {P}_{lb} )} if \frac{{η}_{A} [ s ]}{{η}_{J} [ s ]} \leq \frac{{P}_{ub} - {P}_{lb}}{{P}_{A}} \\ 0 , otherwise\end{matrix} . \qquad ( 9 )$$

Note that since the IRS reflection coefficients are calculated only based on the channels to the client, the IRS reflection matrix θ[s] is independent of the channels to the adversary. Therefore the effective channels to the adversary η_{A}[s] and η_{J}[s] follow exponential distributions with parameter

$${τ}_{A} = \frac{1}{{σ}_{{h}_{Adv}}^{2} + N {σ}_{{h}_{I}}^{2} {σ}_{{g}_{Adv}}^{2}} and {τ}_{J} = \frac{1}{{σ}_{{r}_{Adv}}^{2} + N {σ}_{{r}_{I}}^{2} {σ}_{{g}_{Adv}}^{2}} ,$$

respectively. Then, the expected DEP over slots

$${\overline{P}}_{E} {=}^{Δ} 𝔼 [ {P}_{E} [ s ] ]$$

is given by.

$${\overline{P}}_{E} = min ( λ , 1 - λ ) ( 1 + ρ ln ( ρ ) - {ρ}^{2} ) , \qquad ( 10 )$$

$$where$$

$$ρ = \frac{1}{1 + \frac{{τ}_{A}}{{τ}_{J}} \frac{{P}_{ub} - {P}_{lb}}{{P}_{A}}} . \qquad ( 11 )$$

Here, the expected DEP P̅_{E} is a decreasing function of ρ.

As ρ increases with P_{lb}, the expected DEP P̅_{E} decays with P_{lb}. Also, the expected rate at the client R̅_{C} gets smaller when P_{lb} becomes larger. Therefore, in order to maximize R̅_{C} while satisfying the constraint on the expected DEP, the optimal jamming power lower bound is given by:

$${P}_{lb} = 0 . \qquad ( 12 )$$

Since the expected DEP P̅_{E} and expected rate R̅_{C} are respectively monotonically increasing and decreasing functions of P_{ub}, to maximize R̅_{C}, the optimal P_{ub} given λ and P_{A} should. meet the covertness constraint with equality, i.e., P̅_{E}=ϵ. By setting P_{lb}=6 and defining

$$κ ( λ ) = \frac{{P}_{ub} ( λ )}{{P}_{A} ( λ )} ,$$

ρ becomes

$$ρ = \frac{{τ}_{J}}{{τ}_{J} + {τ}_{A} κ ( λ )} .$$

Here, as P_{E} is an increasing function of κ(λ) when λ is given, κ(λ) that fulfills P̅_{E}=ϵ can be identified, for instance, by leveraging the bisection method. Then, the optimal P_{ub}(λ) for a given λ is expressed as:

$${P}_{ub} ( λ ) = κ ( λ ) {P}_{A} ( λ ) . \qquad ( 13 )$$

With this P_{ub}(λ), the covertness constraint is satisfied, and so the maximum allowable transmit power P_{A}(λ) should be used to maximize the expected rate R̅_{C}. Note that P_{ub}(λ) depends on P_{A}(λ) and P_{ub}(λ) cannot be higher than P_{J,max}. Thus, considering the power budgets at the client and jammer, we obtain the optimal transmit power at the agent P_{A}(λ) for any given λ as:

$${P}_{A} ( λ ) = min ( {P}_{A , max} , \frac{{P}_{J , max}}{κ ( λ )} ) . \qquad ( 14 )$$

With the optimized P_{lb}, P_{ub}(λ), and P_{A}(λ), the covertness constraint is satisfied for every transmission probability at the agent λ.

Due to the fact that there are no closed-form solutions for P_{ub}(λ) and P_{A}(λ), it is intractable to derive an exact expression of the expected rate at the client R̅_{C}. To make the problem tractable, we employ an approximation of R̅_{C} as:

$${\overline{R}}_{C} \approx {\tilde{R}}_{C} {=}^{Δ} λ [ {log}_{2} ( 1 + \frac{{P}_{A} ( λ ) E [ {\vert {h}_{C} [ s ] + {g}_{C}^{T} [ s ] Θ [ s ] {h}_{I} [ s ] \vert}^{2} ]}{E [ {P}_{J} [ s ] ] E [ {\vert {r}_{C} [ s ] + {g}_{C}^{T} [ s ] Θ [ s ] {r}_{I} [ s ] \vert}^{2} ]} ) ] , \qquad ( 15 )$$

$$where$$

$$E [ {\vert {h}_{C} [ s ] + {g}_{C}^{T} [ s ] Θ [ s ] {h}_{I} [ s ] \vert}^{2} ] = \frac{π}{4} N \sqrt{{σ}_{{h}_{I}}^{2} {σ}_{{g}_{C}}^{2} {σ}_{{h}_{C}}^{2}} + ( \frac{{π}^{2} {N}^{2}}{16} + ( 1 - \frac{{π}^{2}}{16} ) N ) {{σ}_{h}^{2}}_{I} {σ}_{{g}_{C}}^{2} + {σ}_{{h}_{C}}^{2} {=}^{Δ} Ω ,$$

$$E [ {P}_{J} [ s ] ] = \frac{{P}_{ub} ( λ )}{2} ,$$

$$E [ {\vert {r}_{C} [ s ] + {g}_{C}^{T} [ s ] Θ [ s ] {r}_{I} [ s ] \vert}^{2} ] = N {σ}_{{r}_{I}}^{2} {σ}_{{g}_{C}}^{2} + {σ}_{{r}_{C}}^{2} = Φ .$$

Then, the approximation of the expected rate \tilde{R}_{C} is given by:

$${\tilde{R}}_{C} = λ {log}_{2} ( 1 + \frac{2 Ω}{κ ( λ ) Φ} ) \qquad ( 16 )$$

Having presented the various equations above, we present a novel methodology to optimize the transmission probability, transmit power at the agent and the reflection matrix of the IRS with the goal of maximizing the achievable rate at a client while ensuring a covertness constraint.

FIG. 3 depicts a flow chart of the novel methodology 300 according to one embodiment of the invention. It allows us to establish a covert communication link between the agent device 102 and the client device 104 using the IRS 106 and the friendly jamming device 110. This includes configuring the IRS 106 for RF communication between the agent device 102 and the client device 104 for covert communications. Plus, it configures the jamming device 110 to generate and broadcast a confusion signal to confuse the adversary device in detecting the existence of the communication between the agent device and the client device. For instance, it may confuse the adversary device in detecting the existence of the communication between the agent device and the client device while alleviating the interference at the client.

In step 310, we provide an intelligent reflecting surface (IRS) to reflect wireless radio frequency (RF) communication signals transmitted from the agent device to the client device, the IRS comprising a two-dimensional array of individually controllable RF reflecting elements. An exemplary IRS 106 is shown in FIGS. 2A and 2B, described above.

Next, in step 320, we provide a jamming device which radiates jamming signals with random power to confuse the adversary device in detecting the existence of the communication between the agent device and the client device. This adds the jamming device 110 to the network. Again, the jamming device's 110 role is to broadcast artificial random jamming signals (not data) with the aim of confusing the adversary. The jamming randomly chooses its jamming power from a uniform distribution in [P_{lb}, P_{ub}].

And, in step 330, we establish a covert RF communication link between the agent device and the client device by determining a transmission probability λ between the agent device and the client device, a transmit power P at an agent, random jamming power of the jamming device P_{J}[s] and an IRS reflection matrix Θ for configuration data for the IRS elements to optimize an achievable data rate at a client R̅_{C} while ensuring covertness of the transmission. An example of step 330 is shown in more detail FIG. 3A and described below.

We can use method 300 for wireless network embodiments where a transmitter (e.g., agent, cellular base station, user equipment) sends a data to its receiver with the aid of an IRS to increase the coverage region and maximize the achievable rate at the client. In specific embodiments, it is suitable for any IRS-assisted networks where there exist security threats, low computational complexity is desirable, and only the statistic of the channel to a potential adversary is available.

Step 330 establishes a covert communication link between the agent device 102 and the client device 104 using the IRS 106. It adaptively reconfigures the wireless network environments via controlled reflections. Again, our method presumes transmissions from the agent device 102 to the client device 104 using the IRS 106. But the roles of the agent and the client can repeatedly change again and again as needed. This step may preferably include establishing a covert RF communication link between the agent device and the client device using the IRS may determining a transmission probability λ between the agent device and the client device, a transmit power P at an agent, random jamming power of the jamming device P_{J}[s] and an IRS reflection matrix Θ for configuration data for the IRS elements to optimize an achievable data rate at a client R̅_{C} while ensuring covertness of the transmission. This step is further explained with respect to sub-steps 332, 334 and 336 in FIG. 3A.

In step 332, we determine the transmission probability λ between the agent device and the client device that optimizes the achievable data rate at the client device R̅_{C} taking into account an expected detection error probability (DEP) at an adversary device. Again, because we are unable to derive an exact expression of the expected rate at the client, we use an approximation thereof, [symbol] .

Here, we note that P̅_{E}=min(λ, 1−λ)ξ where ξ=1+ρ ln(ρ)−ρ². Hence, the value of κ(λ) that meets the covertness constraint with equality fulfills

$$ξ = \frac{ϵ}{min ( λ , 1 - λ )}$$

where ξ is an increasing function of κ(λ) from the fact that ξ is a decreasing function of

$$ρ = \frac{{τ}_{J}}{{τ}_{J} + {τ}_{A} κ ( λ )} .$$

When λ≤0.5, κ(λ) satisfying the condition

$$ξ = \frac{ϵ}{min ( λ , 1 - λ )}$$

decays with λ as ξ gets larger with κ(λ) and

$$\frac{ϵ}{min ( λ , 1 - λ )}$$

becomes smaller with λ. In this sense, if λ≤0.5, to maximize R̅_{C}, λ should be set to 0.5. On the other hand, for λ>0.5, κ(λ) such that

$$ξ = \frac{ϵ}{min ( λ , 1 - λ )}$$

grows with λ. From these observations, we can infer that R̅_{C} is a unimodal function of λ, and therefore there exists a unique maximum in [0.5, 1].

The approximated expected achievable rate maximizing transmission probability λ can be found by solving the following:

$$λ = {arg max}_{λ ∈ [ 0.5 , 1 ]} {\tilde{R}}_{C} . \qquad ( 17 )$$

The arguments of the maxima function (commonly abbreviated as argmax) returns the maximum value for the target function. Thus, Eq. (17) determines the maximum value of \tilde{R}_{C} which is used for λ.

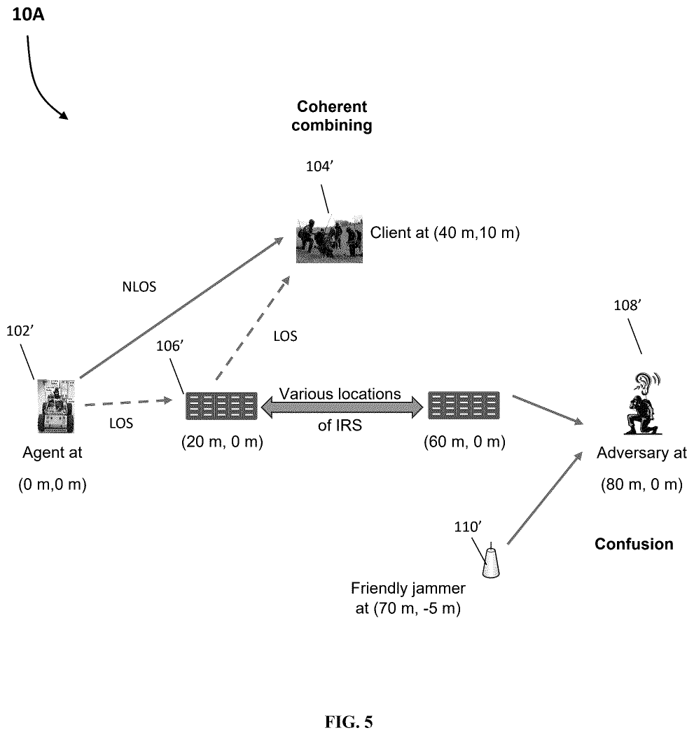

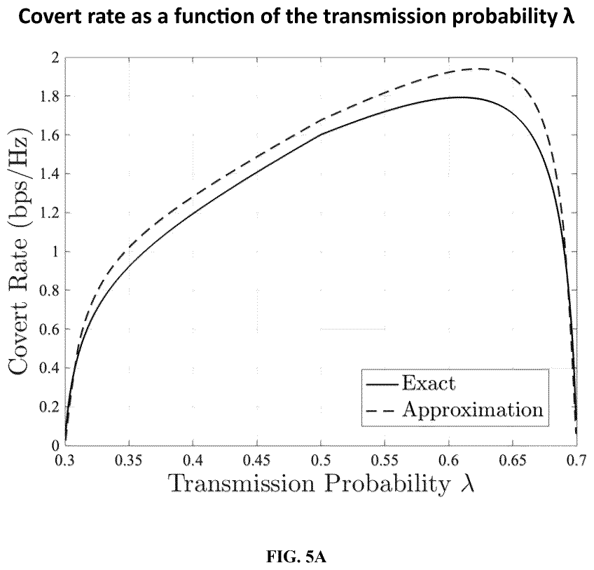

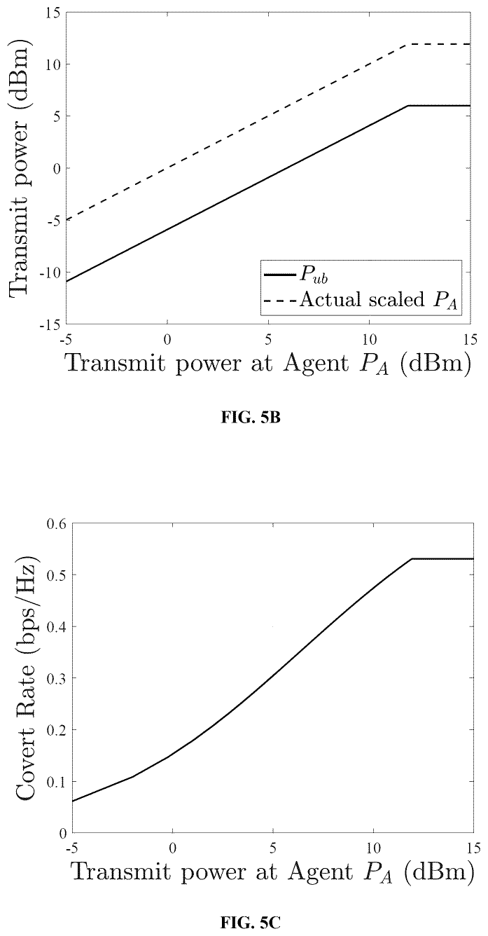

Since \tilde{R}_{C} is a unimodal function of λ, the solution of the problem can be found by exploiting one-dimensional search strategies such am extremum finding technique, like the golden section search method. To solve for this, in various embodiments, we can plot the covert rate (in units of bps/Hz) as a function of transmission probability λ to determine the value of λ for which the covert rate function is maximum. An exemplary plot for the scenario depicted in FIG. 5 is shown in FIG. 5A. The plot there has two curves: one is the exact covert rate R̅_{C} without any approximations, and the other is the derived approximation of the covert rate \tilde{R}_{C}. As we mathematically analyzed, it is shown that the approximation is a unimodal function of the transmission probability (i.e., there is only one peak). Also, it turns out that the exact covert rate is also a unimodal function. The point here is that the value of transmission probability that maximizes the approximation is very close to the point that maximizes the exact covert rate. Due to this fact, our approach which is based on the approximation maximization works well.

Extremum finding techniques (such as the golden section search method) are well-known techniques for analyzing functions. (For more information, see E. K. P. Chong and S. H. Zak, Introduction to Optimization, 4th ed. Hoboken, NY, USA: Wiley, 2013). This can be achieved by suitable data analysis software. For that exemplary scenario plot of FIG. 5A, the covert rate is maximum for λ of approximately 0.625.

Next, in step 334, we determine a transmit power P of the agent that satisfies a covertness constraint for the RF communication for the determined transmission probability A obtained in step 310 and the jamming power P_{J}[s] for jamming device 110. It can broadcast artificial random jamming signals (not data) with the aim of confusing the adversary. The range of random jamming power is between a lower bound P_{lb} to an upper bound P_{ub}. So, there are two optimization variables for the jamming power (P_{lb} and P_{ub}).

As ρ increases with P_{lb}, the expected DEP P̅_{E} decays with P_{lb}. Also, the expected rate at the client R̅_{C} gets smaller when P_{lb} becomes larger. Therefore, in order to maximize R̅_{C} while satisfying the constraint on the expected DEP, the optimal jamming power lower bound is given by P_{lb}=0. [Eq. (12)].

Since the expected DEP P̅_{E} and expected rate R̅_{C} are respectively monotonically increasing and decreasing functions of P_{ub}, to maximize R̅_{C}, the optimal P_{ub} given λ and P_{A} should meet the covertness constraint with equality, i.e., P̅_{E}=ϵ. By setting P_{lb}=6 and defining

$$κ ( λ ) = \frac{{P}_{ub} ( λ )}{{P}_{A} ( λ )} ,$$

ρ becomes

$$ρ = \frac{{τ}_{J}}{{τ}_{J} + {τ}_{A} κ ( λ )} .$$

Here, as P̅_{E} is an increasing function of κ(λ) when λ is given, κ(λ) that fulfills P̅_{E}=ϵ can be identified by leveraging a root-finding method, such as the bisection method as an example. Root-finding methods (such as the bisection method) are well-known techniques for analyzing functions. (For more information, see again E. K. P. Chong and S. H. Zak, Introduction to Optimization, 4th ed. Hoboken, NY, USA: Wiley, 2013).

Then, the optimal P_{ub}(λ) for a given λ is expressed as: P_{ub}(λ)=κ(λ)P_{A}(λ). [Eq. (13)]. With this P_{ub}(λ), the covertness constraint is satisfied, and so the maximum allowable transmit power P_{A}(λ) should be used to maximize the expected rate R̅_{C}. Note that P_{ub}(λ) depends on P_{A}(λ) and P_{ub}(λ) cannot be higher than P_{J,max}. Thus, considering the power budgets at the client and jammer, we obtain the optimal transmit power at the agent P_{A}(λ) for any given λ as:

$${P}_{A} ( λ ) = min ( {P}_{A , max} , \frac{{P}_{J , max}}{κ ( λ )} ) . \qquad [ Eq . ( 14 ) ]$$

To solve for this, in various embodiments, we can plot the actual scaled agent transmit power as a function of P_{A}. An exemplary plot for the scenario depicted in FIG. 5 is shown in FIG. 5B. The plot showing the upper bound of jamming power P_{ub} and actual transmitted transmit power P_{A} at the agent when the transmission probability λ obtained in step 332 is adopted. First, since P_{ub}(λ)=κ(λ)P_{A}(λ), P_{ub}(λ) linearly increases with P_{A}(λ) until P_{ub}(λ) reaches at P_{J,max}. Note that, to satisfy the covertness constraint, the ratio between the powers

$$κ ( λ ) = \frac{{P}_{ub} ( λ )}{{P}_{A} ( λ )}$$

should remain constant. In this sense, even if we want to increase P_{A}(λ) further, the actual transmit power at the agent cannot be increased. Therefore, as shown in the plot, P_{A}(λ) remains the same (about 12 dBm) after P_{ub}(λ) reaches at P_{J,max}. FIG. 5C further shows a plot of the covert rate as a function of P_{A}(λ). It shows the covert rate is a non-decreasing function thereof. Also, as shown in the previous figure, P_{A}(λ) cannot be higher than 12 dBm. Thus, we can see that the covert rate increases as P_{A}(λ) grows, and the covert rate remains the same when P_{A}(λ) is equal or greater than 12 dBm. With the optimized P_{lb}, P_{ub}(λ), and P_{A}(λ), the covertness constraint is satisfied for every transmission probability at the agent λ.

Lastly, in step 336, we determine the IRS reflection matrix θ by determining phase calculations of the n-th IRS elements of the IRS θₙ[s]. This provides configuration data for the reflecting elements of the IRS 106. The instantaneous channels to the adversary (h_{Adv}[s], g_{Adv}[s], and r_{Adv}[s]) and the instantaneous channels from the jammer (r_{C}[s] and r_{I}[s]) are not available at the agent and IRS. Hence, to enhance the achievable rate at the client based on only the available channel information, Θ[s]=diag{e^{jθ}^{₁}^{[s]}, e^{jθ}^{₂}^{[s]}, . . . , e^{jθ}^{_{N}}^{[s]}} is calculated to maximize the strength of the received signal at the client from the agent

$${P}_{A} {\vert {h}_{C} [ s ] + {g}_{C}^{T} [ s ] Θ [ s ] {h}_{I} [ s ] \vert}^{2} .$$

Then, the reflection coefficient θₙ[s] is obtained by: θₙ[s]=arg (h_{C}[s])−arg(g_{C,n}[s])−arg(h_{l,n}[s]), ∀n, where arg(α) is the angle of complex scalar α, and g_{C,n}[s] and h_{I,n}[s] indicate the n-th elements of g_{C}[s] and h_{I}[s], respectively. [Eq. (8)]. The IRS reflection matrix Θ is computed in every communication slot s.

Method 300 may be embodied as software, hardware or some combination thereof. To that ends, computer-executable instructions (code) for implementation may be provided for. One skilled in the art can create suitable instructions (code) for executing the above-mentioned processing and mathematical calculations. In some embodiments, method 300 may be executed by the agent device 102 in cooperation with the IRS 106 and the jamming device 110.

FIG. 4 depicts a simplified high-level block diagram of an exemplary transceiver 400 for an agent device (102 in FIG. 1) in accordance with an embodiment. The transceiver allows the device to both transmit and receive RF signals. In some embodiments, a client device (104 in FIG. 1) and/or a jamming device (110 in FIG. 1) may also include this form of transceiver. The transceiver 400 comprises an antenna 402, an RF transmitter 404, an RF receiver 406, a controller 508 and, optionally, one or more sensors 410. In one embodiment, the transceiver 400 may be specifically configured to execute covert communications software 426 comprising computer-executable instructions or code to perform the method 300 (FIGS. 3 and 3A) as described above.

In one embodiment, the transmitter 404 is a conventional RF transmitter that is controlled by the controller 408 such that the transmitter shall transmit a data carrying communication signal. The transmitter 404 can have the phase of the transmitted signal adjusted by the controller 408. The receiver 406 may be a conventional RF receiver that is controlled by the controller 408. When operating as a client, the receiver 406 receives communications signals from the agent. When the transceiver 400 is a portion of a client, the receiver 406 receives the signals from the agent.

The optional sensors 410 may include one or more of cameras, microphones, multispectral imaging (UV/visible/IR) sensors; antennas (RF; radio); ranging (radar; LIDAR) sensors; location/position sensors (GPS, altitude/depth, etc.), motion sensors (speed/velocity, bearing/trajectory, acceleration, etc.); weather sensors (temperature, pressure, wind speed, ambient lighting, etc.); field sensors (electric, magnetic, vibrations, radiation, biological, etc.) and the like. The signals to/from these sensors 410 are processed by the controller 408 and may be used locally or transmitted to the client from an agent or to an agent from a client.

In one embodiment, the controller 408 comprises at least one processor 412, memory 424 and various support sub-systems and circuits such as, but not limited to, an RF input/output (I/O) interface 414, a clock 418, a phase control adjustor 420, a sensor(s) I/O interface 422, and a communications module 430. The RF input/output (I/O) interface 414 communicates with the RF hardware (e.g., receiver 406 and transmitter 404) so as to control the transmission/receptions of radio signals for Wireless communications. It includes frequency synchronization configured to carry out the novel concert communications methodology including handling the transmission in a manner to support the processing discussed above. The sensor(s) I/O interface 422 communicates with any sensor(s) which the agent or client may be equipped. The clock 418 is used for timing and establishing time slots. In one embodiment, the clock of each agent may be calibrated ahead of time such. The clock may also be synchronized to an external source such a satellite navigation system (e.g., a Global Positioning System (GPS)). In other embodiments, the agent could interface with the client (or another entity) for clock calibration. The communications module 430 generate signals for communications, including a RF communications signal generator 432 as generally known in the art. The module 430 may be capable of handling analog and/or digital signals, the later including packetized data. If desired, the signal generator 432 may provide encryption for provided confidential signals as known in the art.

In an embodiment, the controller 408 includes a processor 412 coupled to a memory 424. The processor 412 may be one or more of, or combinations thereof, microprocessors, microcontrollers, application specific integrated circuits (ASICs), and/or the like. The memory 424 may be any form of read only memory, random access memory or combinations thereof. For instance, the memory 424 can be a non-transitory computer readable media that stores secure communications software 426 and data 436 such that the processor 412 may execute the software 426 to implement the method 300 of FIG. 3 to perform covert communications in accordance with embodiments of the invention described above. Portions of the method 300 are appropriately performed by a controller 408 in the agent as described above. The data 436 may include communications data, control data and feedback data.

Now, we investigate the impact of the number of IRS elements N on the expected DEP P̅_{E} in Eq. (10). First, after some manipulations, ρ in Eq. (11) can be rewritten as

$$ρ = \frac{{σ}_{{h}_{I}}^{2} {σ}_{{g}_{W}}^{2} N + {σ}_{{h}_{W}}^{2}}{( {σ}_{{h}_{I}}^{2} {σ}_{{g}_{W}}^{2} \frac{{P}_{ub}}{{P}_{A}} {σ}_{{r}_{I}}^{2} {σ}_{{g}_{W}}^{2} ) N + {σ}_{{h}_{W}}^{2} + \frac{{P}_{ub}}{{P}_{A}} {σ}_{{r}_{W}}^{2}} , \qquad ( 18 )$$

and, by differentiating ρ with respect to N, we have

$$\frac{d ρ}{dN} = \frac{( {σ}_{{h}_{I}}^{2} {σ}_{{r}_{W}}^{2} - {σ}_{{h}_{W}}^{2} {σ}_{{r}_{I}}^{2} ) \frac{{P}_{ub}}{{P}_{A}} {σ}_{{g}_{W}}^{2}}{{( ( {σ}_{{h}_{I}}^{2} {σ}_{{g}_{W}}^{2} + \frac{{P}_{ub}}{{P}_{A}} {σ}_{{r}_{I}}^{2} {σ}_{{g}_{W}}^{2} ) N + {σ}_{{h}_{W}}^{2} + \frac{{P}_{ub}}{{P}_{A}} {σ}_{{r}_{W}}^{2} )}^{2}} , \qquad ( 19 )$$

Note that P̅_{E} gets smaller when p becomes higher. Thus, by defining

$${α}_{A} {=}^{Δ} \frac{{σ}_{{h}_{I}}^{2}}{{σ}_{{h}_{W}}^{2}} and {α}_{J} {=}^{Δ} \frac{{σ}_{{r}_{I}}^{2}}{{σ}_{{r}_{W}}^{2}} ,$$

P̅_{E} is an increasing (or a decreasing) function of the IRS element number N if α_{A}>α_{J} (or α_{A}>α_{J}). Here, α_{A} (or α_{J}) stands for the large-scale gain of the channel between the agent 102 (or the jammer 110) and the IRS 106 which is scaled by the large-scale gain of the direct channel between the agent 102 (or the jammer 110) and the adversary 108. In this sense, we can interpret that increasing N is beneficial (or harmful) to enhance the DEP P̅_{E} when the scaled channel gain between the agent 102 and the IRS α_{A} is smaller (or larger) than the scaled channel between the jammer and the IRS α_{J}. The case with α_{A}<α_{J} means that the impact of the channel from the agent 102 to the adversary 108 through the IRS 106 is smaller than that of the channel from the jammer 110 to the adversary 108 via the IRS 106. This leads to an increased DEP since the jamming signal can confuse the adversary 108 more efficiently.

As a special case, when the channel gains of the direct links

$${σ}_{{h}_{w}}^{2} and {σ}_{{r}_{w}}^{2}$$

are the same, the DEP P̅_{E} gets bigger with N when

$${σ}_{{h}_{1}}^{2} < {σ}_{{r}_{1}}^{2} .$$

Also, if the gains of the channels to the IRS

$${σ}_{{h}_{1}}^{2} and {σ}_{{r}_{1}}^{2}$$

are the same, the DEP P̅_{E} becomes greater with N when

$${σ}_{{h}_{w}}^{2} > {σ}_{{r}_{w}}^{2} .$$

With respect to FIG. 5, in FIG. 5A-5C, we provide some numerical simulation results to demonstrate the effectiveness of the novel methodology 300 for the exemplary network scenario 10A. More specifically, for the exemplary scenario 10A, depicted in FIG. 5, the positions of the agent 102′, the client 104′, the adversary 108′ and the jammer 110′ are fixed, and positions of the IRS 102′ is changing. Here, the agent 102′ is located at (0 m, 0 m), the client 104′ is located at (40 m, 10 m), the adversary 108′ is located at (80 m, 0 m), and the jammer 110′ is located at (70 m, −5 m), respectively. We consider different horizontal locations of the IRS 106′ between (20 m, 0 m) and (60 m, 0 m). All distances are given in units of meters (m).

In FIG. 5A, we plot the covert rate (in units of bps/Hz) as a function of transmission probability 2. Here, we make the following network assumptions: N=200, P_{A,max}=15 dB; P_{J,max}=15 dBm;

$${σ}_{C}^{2} = {σ}_{Adv}^{2} = - 80 dBm ;$$

the location of agent=[40 m,0 m]; the location of client=[40 m, 10 m]; the location of adversary=[80 m, 0 m]; the location of IRS=[40 m, 0 m]; the location of jammer=[60 m, −5 m]; and the target DEP ϵ=0.3. Again, as previously discussed, the plot has two curves: one is the exact covert rate R̅_{C} without any approximations, and the other is the derived approximation of the covert rate \tilde{R}_{C}. For that exemplary scenario plot here, the covert rate is maximum for λ of around 0.625.

In FIG. 5B, we plot the upper board of the jamming power and the actual scaled agent transmit power as a function of P_{A}. Here, we make the following network assumptions: N=200; P_{A,max}=15 dB; P_{J,max}=6 dBm;

$${σ}_{C}^{2} = {σ}_{Adv}^{2} = - 80 dBm ;$$

the location of agent=[0 m, 0 m]; the location of client=[40 m, 10 m]; the location of adversary=[80 m, 0 m]; the location of IRS=[40 m, 0 m]; the location of jammer=[40 m, −5 m]; and the target DEP ϵ=0.3. The nature of the plot is discussed above. In sum, the plots show P_{A}(λ) remains the same (about 12 dBm) after P_{ub}(λ) reaches at P_{J,max}. FIG. 5C is a plot of the covert rate as a function of P_{A}(λ). It shows the covert rate is a non-decreasing function thereof. Also, as shown in the previous figure, P_{A}(λ) cannot be higher than 12 dBm. Thus, we can see that the covert rate increases as P_{A}(λ) grows, and the covert rate remains the same when P_{A}(λ) is equal or greater than 12 dBm. The network setup for the plot of FIG. 5C is the same as that for FIG. 5B.

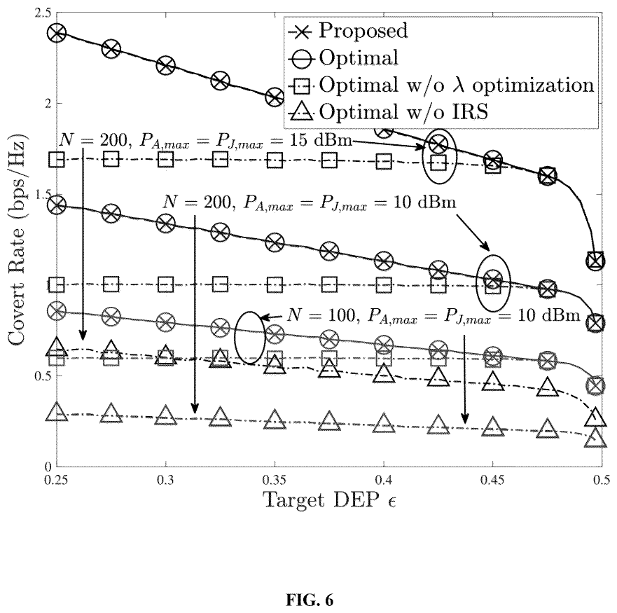

FIGS. 6-8 are some additional plots of covert data rate based on the exemplary network scenario in FIG. 5. Here, we model the large-scale channel gain between two nodes with distance d by σ² (d) (in dB)=Gₜ+Gᵣ−37.5−22 log₁₀(d) when line-of-sight (LOS), and σ²(d) (in dB)=Gₜ+Gᵣ−35.1−36.7 log₁₀(d) when non-LOS (NLOS) where Gₜ and Gᵣ respectively denote the transmitter and receiver gains. Unless otherwise stated, we assume P_{A,max}=P_{J,max}=15 dBm,

$${σ}_{W}^{2} = {σ}_{W}^{2} = - 80 dBm ,$$

Gₜ=Gᵣ=0 dBi, and only the link between the agent 102′ and the IRS 106′ and the link between the IRS 106′ and the client 104′ are LOS.

FIG. 6 demonstrates the expected covert rate R̅_{C} in Eq. (6) with various values of ϵ, N, P_{A,max}, and P_{J,max}. Here, the optimal performance is obtained by exhaustively searching the optimal solution that maximizes the exact expected achievable rate R̅_{C} in Eq. (6). The optimal without λ optimization means the case where the optimal P_{A}, P_{lb}, and P_{ub} are adopted when On is computed as in Eq. (8) and λ is fixed to 0.5 Also, the optimal without IRS is the case where the optimal P_{PA}, P_{lb}, P_{ub} and λ are identified assuming that there is no IRS. First, we can observe that the novel methodology exhibits near optimal performance with only one-dimensional line search methods. In addition, by comparing the proposed technique with the optimal without λ optimization and the optimal without IRS, it is shown that the performance is significantly enhanced by jointly optimizing P_{A}, P_{lb}, P_{ub}, Θ, and λ. Lastly, we see that the covert rate is improved when the IRS element number N and available power budgets (P_{A,max} and P_{J,max}) become larger.

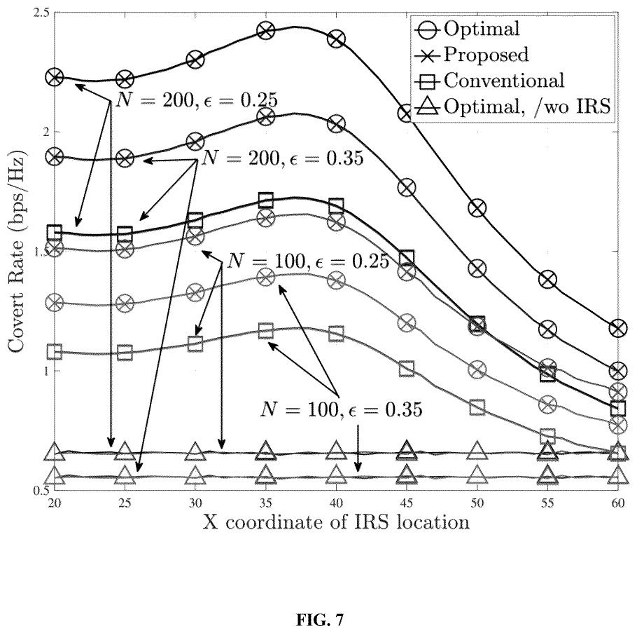

In FIG. 7, we examine the covert rate as a function of X_{IRS} where the IRS is located at (X_{IRS}, 0) considering different values of N and E. We can see that the performance of the proposed algorithm is indistinguishable from the optimal performance. Since the IRS reflection matrix maximizes the received signal strength at the client 104′ from the agent 102′, the covert rate is maximized when X_{IRS} is between the X coordinates of the locations of the agent 102′ and the client 104′ which are 0 and 40, respectively. It is also observed that the covert rate gets higher when the number of IRS elements N increases or the target DEP ϵ decreases.

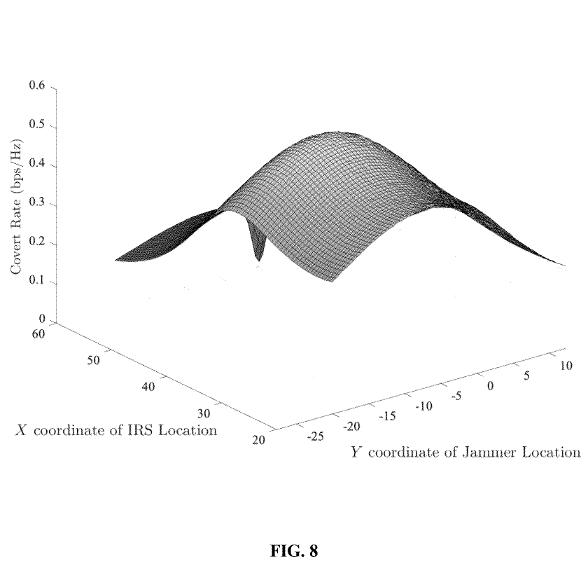

FIG. 8 illustrates the expected covert rate R̅_{C} in Eq. (6) with the different locations of the IRS and jammer where the IRS and jammer are positioned at (X_{IRS}, 0) and (60, Y₁), respectively. First of all, it is seen that R̅_{C} is highly related to the locations of the IRS and jammer. Also, the optimal location of the IRS (or the jammer) changes when the location of the jammer (or the IRS) varies. Therefore, it is important to jointly optimize the locations of the IRS and jammer to enhance the covert rate.

In sum, we have shown the joint optimization of the transmit power at the agent, jamming power, IRS reflection matrix, and transmission probability for IRS-aided covert communication with a friendly jammer. We disclose a novel wireless system and methodology that experiences near optimal performance with only one-dimensional search methods. Also, we have analytically explored the influence of the number of IRS elements on the DEP at the adversary, and identified the case where increasing the IRS element number is beneficial to improve the DEP.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, and to describe the actual partial implementation in the laboratory of the system which was assembled using a combination of existing equipment and equipment that could be readily obtained by the inventors, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

We claim:

1. A method for covert wireless RF communications between an agent device and a client device in the presence of an adversary device which attempts to detect the existence of the transmission of the RF communication between the agent and client, the method comprising:
providing an intelligent reflecting surface (IRS) to reflect wireless radio frequency (RF) communication signals transmitted from the agent device to the client device, the IRS comprising a two-dimensional array of individually controllable RF reflecting elements;
providing a jamming device which radiates jamming signals with random power to confuse the adversary device in detecting the existence of the communication between the agent device and the client device; and
establishing a covert RF communication link between the agent device and the client device using the IRS that optimizes the transmission probability, transmit power at an agent, and the reflection matrix of an IRS for covert RF communications.

2. The method of claim 1, wherein establishing the covert communication link between the agent device and the client device using the IRS that optimizes the transmission probability, transmit power at an agent, and the reflection matrix of an IRS for covert RF communications comprises:
determining a transmission probability λ between the agent device and the client device, a transmit power P at an agent, random jamming power of the jamming device P_{J}[s] and an IRS reflection matrix Θ for configuration data for the IRS elements to optimize an achievable data rate at a client R̅_{C} while ensuring covertness of the transmission.

3. The method of claim 2, wherein said determining comprises:
a. determining a transmission probability λ between the agent device and the client device that optimizes the achievable data rate at the client device taking into account an expected detection error probability (DEP) at an adversary device;
b. determining the transmit power P of the agent that satisfies covertness of the transmission for the RF communication for the determined transmission probability λ and the interval of random jamming power P_{J}[s]; and
c. determining phase calculations of the n-th IRS elements of the IRS θₙ[s].

4. The method of claim 2, wherein an approximation of achievable rate at the client R̅_{C} is used for the actual achievable data rate at the client R̅_{C}.

5. The method of claim 3, wherein the determining in step a is performed using an extremum-finding algorithm.

6. The method of claim 5, wherein the extremum-finding algorithm is a golden section search scheme.

7. The method of claim 3, wherein the obtaining in step b is performed using a root-finding algorithm.

8. The method of claim 7, wherein the root-finding algorithm is a bisection method.

9. The method of claim 3, wherein the IRS reflection matrix Θ=diag{e^{jθ}^{₁}, e^{jθ}^{₂}, . . . , e^{jθ}^{_{N}}} and the determining in step c is computed according to the following equation:
$${θ}_{n} = arg ( {h}_{C} ) - arg ( {g}_{C , n} ) - arg ( {h}_{I , n} ) , ∀ n ,$$
where arg(α) is the angle of complex scalar α, and g_{C,n} and h_{I,n} indicate the n-th elements of g_{C} and h_{I} of the IRS, respectively.

10. The method of claim 9, further comprising: wirelessly transmitting the determined IRS reflection matrix Θ from the agent device to the IRS.

11. The method of 3, further comprising: configuring the IRS for RF communication between the agent device and the client device based on the determined IRS reflection matrix Θ.

12. The method of 2, further comprising: configuring the jamming device to operate with random jamming power.

13. A wireless network comprising:
an intelligent reflecting surface (IRS) comprising a 2D array individually-controllable RF reflecting elements to reflect a wireless radio frequency (RF) signals transmitted from an agent device to an client device;
a jamming device which radiates jamming signals with random power to confuse the adversary device in detecting the existence of the communication between the agent device and the client device; and
a controller configured to establish a covert RF communication link between the agent device and the client device using the IRS that optimizes the transmission probability, transmit power at an agent, and the reflection matrix of an IRS for covert RF communications.

14. The wireless network of claim 13, wherein, in establishing the covert communication link between the agent device and the client device using the IRS that optimizes the transmission probability, transmit power at an agent, and the reflection matrix of an IRS for covert RF communications, the controller is configured to: determine a transmission probability λ between the agent device and the client device, a transmit power P at an agent, random jamming power of the jamming device P_{J}[s] and an IRS reflection matrix Θ for configuration data for the IRS elements to optimize an achievable data rate at a client R̅_{C} while ensuring covertness of the transmission.

15. The wireless network of claim 14, wherein, in establishing the covert communication link between the agent device and the client device by said determining, the controller is configured to:
a. determine a transmission probability λ between the agent device and the client device that optimizes the achievable data rate at the client device taking into account an expected detection error probability (DEP) at an adversary device;
b. determine the transmit power P of the agent that satisfies covertness of the transmission for the RF communication for the determined transmission probability λ and the interval of random jamming power P_{J}[s]; and
c. determine phase calculations of the n-th IRS elements of the IRS θₙ[s].

16. The wireless network of claim 14, wherein the controller uses an approximation of achievable rate at the client R̅_{C} for the actual achievable data rate at the client R̅_{C}.

17. The wireless network of claim 15, wherein the determining in step a is performed using an extremum-finding algorithm.

18. The wireless network of claim 17, wherein the obtaining in step b is performed using a root-finding algorithm.

19. The wireless network of claim 15, wherein the IRS reflection matrix Θ=diag{e^{jθ}^{₁}, e^{jθ}^{₂}, . . . , e^{jθ}^{_{N}}} and the determining in step c is computed according to the following equation:
$${θ}_{n} = arg ( {h}_{C} ) - arg ( {g}_{C , n} ) - arg ( {h}_{I , n} ) , ∀ n ,$$
where arg(α) is the angle of complex scalar α, and g_{C,n} and h_{I,n} indicate the n-th elements of g_{C} and h_{I} of the IRS, respectively.

20. The wireless network of claim 13, wherein there IRS comprises at least 20 RF reflecting elements.

21. The wireless network of claim 20, wherein each of the individually controllable RF reflecting elements is configured to provide a phase shift to the reflected signal.

22. The wireless network of claim 13, further comprising at least one agent device and at least one client device.
